(19) United States
(12) Patent Application Publication
(10) Pub. No.: US 2025/0191202 A1
(43) Pub. Date: Jun. 12, 2025

(54) POST-ALIGNMENT ASSESSMENT AND PROCESSING FOR PATHOLOGY IMAGES

(71) Applicant: Verily Life Sciences LLC, Dallas, TX (US)

(72) Inventor: Saurabh Vyawahare, Mountain View, CA (US)

(21) Appl. No.: 18/966,596

(22) Filed: Dec. 3, 2024

Related U.S. Application Data
(60) Provisional application No. 63/607,675, filed on Dec. 8, 2023.

(51) Int. Cl. G06T 7/33; G06T 7/00

(52) U.S. Cl. CPC G06T 7/337; G06T 7/0014; G06T 2207/10056; G06T 2207/10064; G06T 2207/20016; G06T 2207/20081; G06T 2207/30004; G06T 2207/30168

(57) ABSTRACT

Systems and methods for assessing and processing post-alignment pathology images are provided. A computing device accesses a pair of images of a tissue sample, including a first image of a first modality and a second image of a second modality. The computing device generates multiple image patch pairs from the pair of images. Each image patch pair includes a first image patch sampled from a location in the first image and a second image patch sampled from the same location in the second image. The computing device determines multiple translational alignment vectors corresponding to the multiple image patch pairs by minimizing image distance metrics corresponding to the multiple image patch pairs. An image mask for the pair of images can be generated based on the plurality of translational alignment vectors corresponding to the plurality of image patch pairs.

### CROSS-REFERENCE TO RELATED APPLICATIONS

This application claims priority to U.S. Provisional Patent Application No. 63/607,675, filed Dec. 8, 2023, titled “POST-ALIGNMENT ASSESSMENT AND PROCESSING FOR PATHOLOGY IMAGES,” the entirety of which is hereby incorporated by reference.

### BACKGROUND

Image alignment is the process of overlaying images of the same scene under different viewpoints, with different light conditions, at different times, or using different sensors. An image alignment pipeline takes two input images and transforms them into a common coordinate system, using different alignment techniques, such as feature-based keypoint correspondence, similarity measures, or machine learning algorithms. Image alignment is a crucial step for many types of image processing, for example, object recognition, image fusion, panorama creation, rendering enhancement, in different practical fields, such as photography, video generation, medical diagnosis, autonomous vehicles, astronomy, and research.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method. The computer-implemented method includes accessing a pair of images corresponding to a tissue sample including a first image of a first modality and a second image of a second modality. The computer-implemented method also includes generating multiple pairs of image patches from the pair of images. Each pair of image patches includes a first image patch sampled from a first location in the first image and a second image patch from a second location in the second image. The first location in the first image corresponds to the second location in the second image. The computer-implemented method also includes determining multiple translational alignment vectors corresponding to the multiple pairs of image patches by determining an image distance metric between the first image patch and the second image patch in each pair of image patches and determining a translational alignment vector for the first image patch in reference to the second image patch by minimizing the image distance metric. The computer-implemented method also includes generating an image mask for the pair of images based on the plurality of translational alignment vectors corresponding to the plurality of image patch pairs. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 illustrates an example imaging system in which techniques relating to post-alignment assessment and processing of pathology images may be implemented, according to at least one example.

FIG. 2 illustrates an example image pair for post-alignment assessment and processing, according to at least one example.

FIG. 3 illustrates an example pathology image applied with a post-alignment assessment mask, according to at least one example.

FIG. 4 illustrates an example pathology image with translational vectors, according to at least one example.

FIG. 5 illustrates an example flowchart illustrating a process for generating an image mask based on alignment quality assessment, according to at least one example.

FIG. 6 illustrates an example flowchart illustrating a process for determining a translational alignment vector for an image patch pair from a pair of images, according to at least one example.

FIG. 7 illustrates an example system for implementing techniques relating to post-alignment assessment and processing of pathology images, according to at least one example.

### DETAILED DESCRIPTION

Examples are described herein in the context of techniques for post-alignment assessment and processing of pathology images. Those of ordinary skill in the art will realize that the following description is illustrative only and is not intended to be in any way limiting. For example, the techniques described herein can be used to assess and process any suitable set of images including those used outside of pathology. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

The techniques described herein may be used to assess and process post-alignment pathology images. In image pathology applications, it may be preferable that two images be precisely aligned. These images may be of serial cross-sections of a biopsied tissue or of the same tissue sample taken with different imaging modalities. An alignment pipeline can perform alignment of these images. After the alignment is done, an assessment of the alignment quality is usually performed by humans. Problem areas can be identified and annotated by hand using a user interface of a computing system. Problem areas can be discarded, and only high-quality portions of paired images may be used for training machine learning models or for other suitable purposes. However, since the alignments are rarely perfect at the pixel-to-pixel level, human assessment can be time-consuming, labor intensive, and error prone. The described techniques provide for a computational method for automatically assessing post-alignment images and generating an alignment quality assessment mask for processing the post-alignment images.

In an illustrative example, a computing device or a remote server may be used for assessing and processing post-alignment pathology images. A pair of pathology images, including a first image and a second image for the same tissue sample, may be obtained from different imaging modalities. For example, one image may be from a bright-field imaging system and the other may be from a fluorescence imaging system. Pathology images can be large, for example 50,000 by 50,000 pixels, and cannot all be processed at once. Thus, the pathology images can be divided into smaller parts, which can be called image patches. Multiple image patch pairs can be generated from the pair of pathology images. Each pair of image patches includes a first image patch sampled from a first location in the first image and a second image patch sampled from a second location in the second image. The first location in the first image corresponds to the second location of the second image. An image distance metric between the first image patch and the second image patch can be determined for each pair of image patches. The image distance metric indicates a matching level between the first image patch and the second image patch in each pair of image patches. A translational alignment vector for the first image patch can be determined in reference to the second image patch by minimizing the image distance metric. Multiple translational alignment vectors can be determined corresponding to the multiple pairs of image patches. An image mask for the pair of pathology images can be determined based on the multiple translational alignment vectors. For example, a magnitude of each translational alignment vector can be compared with a predetermined threshold. If the magnitude is equal to or above the predetermined threshold value, it indicates that the alignment of the corresponding pair of image patches is of low quality and the corresponding image patch pair can be filtered out (e.g., masked) from the pair of pathology images. If the magnitude is below the predetermined threshold value, the corresponding image patch pair are kept in the pair of pathology images for further uses.

The pair of pathology images can be processed by the computing device by removing image patches of low alignment quality based on the image mask. The processed pair of pathology images can be used for training a machine learning model for certain suitable purposes, such as object identification and medical diagnosis. However, the techniques described herein may be used to assess and process other types of post-alignment images in medical fields, such as radiology images or ultrasound images, or other types of post-alignment images in other fields, such as radar images, Light Detection and Ranging (LiDAR) images, infrared images, satellite images, or images from different types of cameras.

The techniques in the present disclosure save time for post-alignment quality assessment and processing, compared to manual assessment. Generating post-alignment assessment masks at patch levels by determining translational alignment vectors at patch levels saves computational resources, compared to generating masks at pixel levels. Meanwhile, applying an optimization algorithm to an image pyramid with various resolution values of image representations of an image patch also saves processing power and arriving at the minimal image distance metric faster. In addition, equipped with the post-alignment assessment and processing techniques in the present disclosure, less compute-intensive alignment algorithms may be employed to provide aligned images of comparable alignment qualities for machine learning training or other purposes.

This illustrative example is given to introduce the reader to the general subject matter discussed herein and the disclosure is not limited to this example. The following sections describe various additional non-limiting examples relating to assessing and processing post-alignment pathology images.

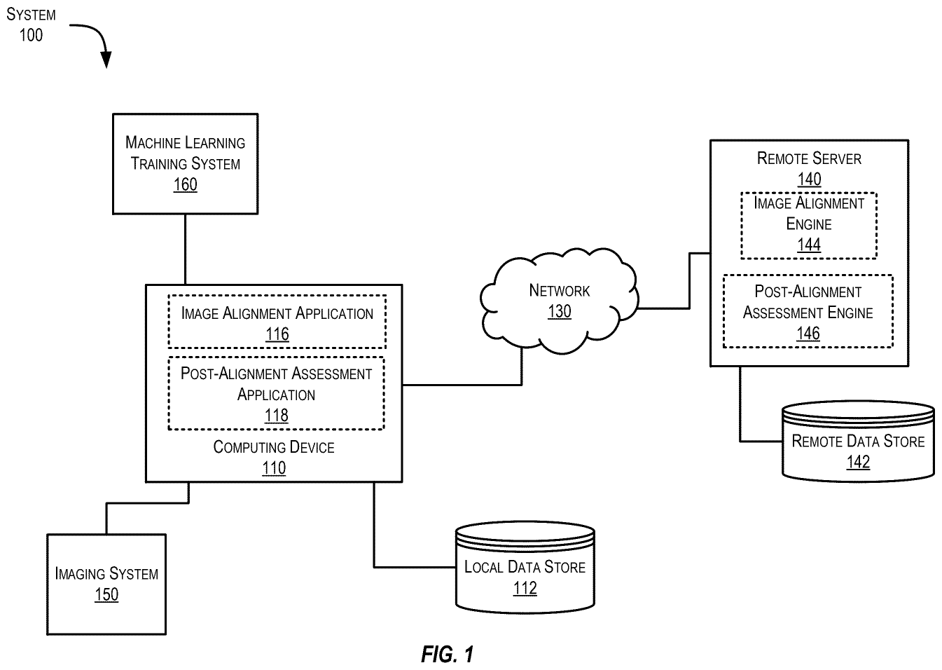

Turning now to the figures, FIG. 1 illustrates an example imaging system 100 in which techniques relating to post-alignment assessment and processing of pathology images may be implemented, according to at least one example. The system 100 includes a computing device 110, which can include an image alignment application 116 and a post-alignment assessment application 118. The computing device 110 is connected to an imaging system 150, a local data store 112, and a machine learning training system 160. The computing device 110 is also connected to a remote server 140 via one or more communication networks 130. The remote server 140 is, in turn, connected to a remote data store 142.

The imaging system 150 can include one or more types of imaging systems, for example, bright-field microscopy, fluorescence microscopy, and any other suitable imaging techniques for pathology tissue samples. The pathology images captured by the imaging system 150 can be stored in the local data store 112. The imaging system 150 can be optional.

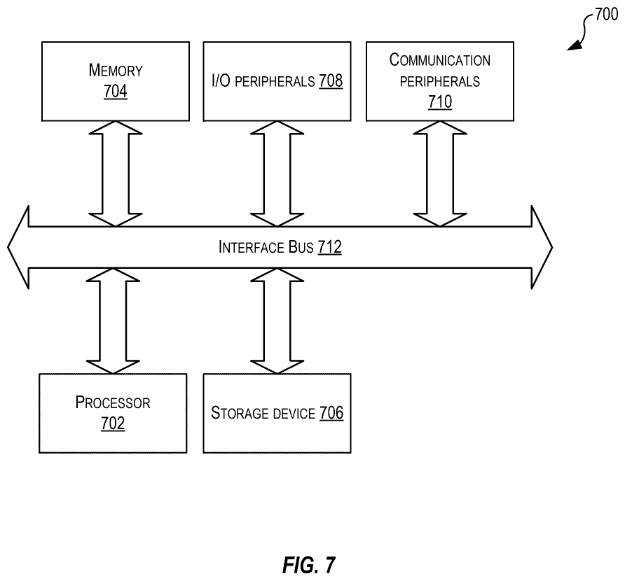

The computing device 110 may be any suitable computing device including a desktop computer, a server computer, a tablet, a laptop computer, a microprocessor and coupled memory, and any other suitable combination of the foregoing. In some examples, the computing device 110 may include one or more ports for input/output components, such as a display, keyboard, keypad, mouse, and the like. In some examples, the computing device 110 is integrally formed with the imaging system 150 and configured to control the operation of the imaging system 150. An example of components that may be included in the computing device 110 is shown in FIG. 7.

The computing device 110 can include an image alignment application 116 for aligning tissue images to create aligned image pairs (or triplets, quartet, etc.). The tissue images may be for serial cross sections of a biopsied tissue or for the same tissue sample with different imaging modalities. The tissue images can be captured from the image system 150 or pre-captured by another imaging system and stored in a local data store 112. The image alignment application 116 can implement one or more alignment algorithms to transform two or more images of the same tissue sample into a common coordinate system. The alignment algorithm can be based on feature-based keypoint correspondence, similarity measures, or machine learning models. The image alignment application 116 can be optional.

The computing device 110 also includes a post-alignment assessment application 118 for assessing and processing post-alignment images. The post-alignment images can be directly from the image alignment application 116. Alternatively, or additionally, the local data store 112 stores pre-aligned images from the image alignment application 116 or another source. The post-alignment assessment application 118 can access the pre-aligned images stored in the local data store 112 for post-alignment assessment and processing.

In some examples, a pair of pre-aligned images includes a first bright-field image and a second fluorescence image for the same tissue sample. The post-alignment assessment application 118 generates multiple pairs of image patches from the pair of pre-aligned images. Each pair of image patches includes a first image patch sampled from a first location in the first image and a second image patch sampled from a second location in the second image. The first location in the first image is aligned with the second location in the second image in the pair of pre-aligned images. The multiple pairs of image patches can be extracted from the pair of pre-aligned images at a given magnification. Image patches with low pixel intensity may indicate corresponding portions of a slide are non-tissue regions. These image patches can be discarded for post-alignment quality assessment. In some examples, if the pixel intensity of an image patch at 95^{th} percentile does not exceed an intensity threshold, the corresponding pair of image patches is discarded. In addition, the multiple pairs of image patches can be converted to grayscale with pixel intensity values between 0.0 and 1.0. This ensures both image patches in a pair are at the same scale.

For each pair of image patches, the post-alignment assessment application 118 can determine an image distance metric between the first image patch and the second image patch, indicating a matching level between the first image patch and the second image patch. The post-alignment assessment application 118 can also determine a translational alignment vector for the first image patch in reference to the second image patch by minimizing the image distance metric. The translational alignment vector for the first image patch corresponds to an (x,y) location that the first image patch can move to in reference to the second image patch so that the image distance metric is minimized between the two image patches. In some examples, the post-alignment assessment application 118 generates an image pyramid for the first image patch, including the first image patch itself at the bottom level of the pyramid and multiple visual representations of the first image patch with reduced resolution values at higher levels. The higher the level is in the pyramid, the lower the resolution level is. A first translational alignment vector can be obtained by minimizing the image distance metric between the first visual representation of the first image patch with the lowest resolution value (at the top level of the pyramid) and the second image patch using an optimization algorithm. A second translational alignment vector can be obtained by minimizing the image distance metric between the second visual representation of the first image patch with a resolution level higher than the lowest resolution level and the second image patch based on the first translational alignment vector using the optimization algorithm. This way, from the top of the pyramid to the bottom of the pyramid, the translational alignment vector for the first image patch can be obtained in reference to the second image patch using the translational alignment vector for a visual representation of the first image patch above the bottom level of the pyramid. The image pyramid scheme can reduce the number of computation steps, thus use fewer computational resources, compared to determining the translational alignment vector for the first image patch by directly minimizing the image distance metric between the first image patch and the second image patch. Multiple translational alignment vectors can be obtained for the multiple image patch pairs.

The post-alignment assessment application 118 can determine a magnitude for each of the multiple translational alignment vectors and compares the magnitudes with a predetermined threshold value. If the magnitude of a translational alignment vector is less than the predetermined threshold value, it indicates an acceptable alignment quality and the corresponding image patch pair can be kept. If the magnitude of the translational alignment vector is equal to or greater than the predetermined threshold value, it indicates an unacceptable alignment quality and the corresponding image patch pair can be filtered out (or masked). Thus, a post-alignment assessment mask is generated for the pair of pre-aligned images based on the comparison between the magnitudes of translational alignment vectors for the multiple image patch pairs and the predetermined threshold value. The predetermined threshold value can be adjusted based on a level of alignment quality that is acceptable to an associated user.

In some examples, the post-alignment assessment application 118 can apply the post-alignment assessment mask to a corresponding pair of pre-aligned images to filter out (or mask) image patches with poor alignment and generate an updated pair of pre-aligned images. The updated pair of pre-aligned images can be provided to the machine learning training system 160. The machine learning training system 160 can train a machine learning model using the updated pair of pre-aligned images as part of training data. If post-alignment assessment masks are applied to all pairs of pre-aligned images which is training data for a machine learning model, the quality of the training data is improved and thus the trained machine learning model.

In some examples, the post-alignment assessment application 118 can provide the post-alignment assessment mask or the translational alignment vectors for a corresponding pair of pre-aligned images to the image alignment application 116 for realigning the pair of pre-aligned images. In some examples, the post-alignment assessment application 118 can realign the pair of pre-aligned images based on the generated post-alignment assessment mask or the translational alignment vectors.

The local data store 112 stores pre-captured pathology images from the imaging system 150 or a different imaging system and pre-aligned images from the image alignment application 116 or another source. The local data store 112 can also store image patches, translational alignment vectors, post-alignment assessment masks, updated pre-aligned images, and re-aligned images.

The remote server 140 can provide the image alignment application 116 and the post-alignment assessment application 118 installed on the computing device 110. In some examples, the remote server 140 includes an image alignment engine 144, similar to the image alignment application 116, for aligning pathology images; and a post-alignment assessment engine 146, similar to the post-alignment assessment application 118, for assessing pre-aligned pathology images and generating post-alignment assessment masks. The remote server 140 can access tissue images captured by the imaging system 150 or stored in the local data store 112. The remote server 140 can also access aligned images by the image alignment application 116 or stored in local data store 112. Alternatively, or additionally, the remote server 140 can access pre-captured pathology images or pre-aligned images stored in remote data store 142. In some examples, the machine learning training system 160 is connected to the remote server 140 directly. In some examples, the machine learning training system 160 is part of the remote server 140.

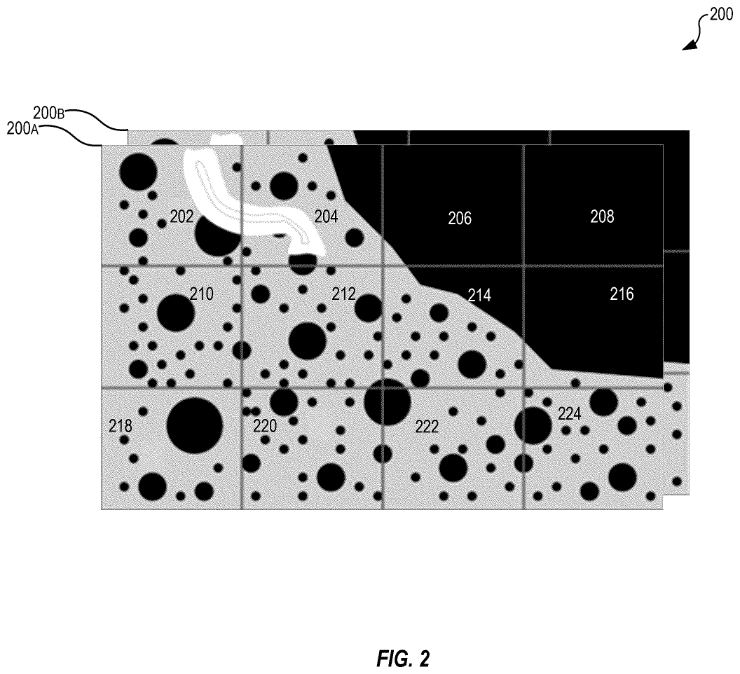

FIG. 2 illustrates an example image pair 200 for post-alignment assessment and processing, according to at least one example. The example image pair 200 includes two images 200A and 200B. The two images 200A and 200B are fluorescence images captured for two serial cross sections of the same tissue. The gray region in images 200A and 200B represents tissue and the black region represents non-tissue space. The image pair 200 is divided by a 4 by 3 grid into 12 pairs of image patches 202, 204, 206, 208, 210, 212, 214, 216, 218, 220, 222, 224, each pair of image patches includes an image patch at a location in image 200A and an image patch at the same location in image 200B.

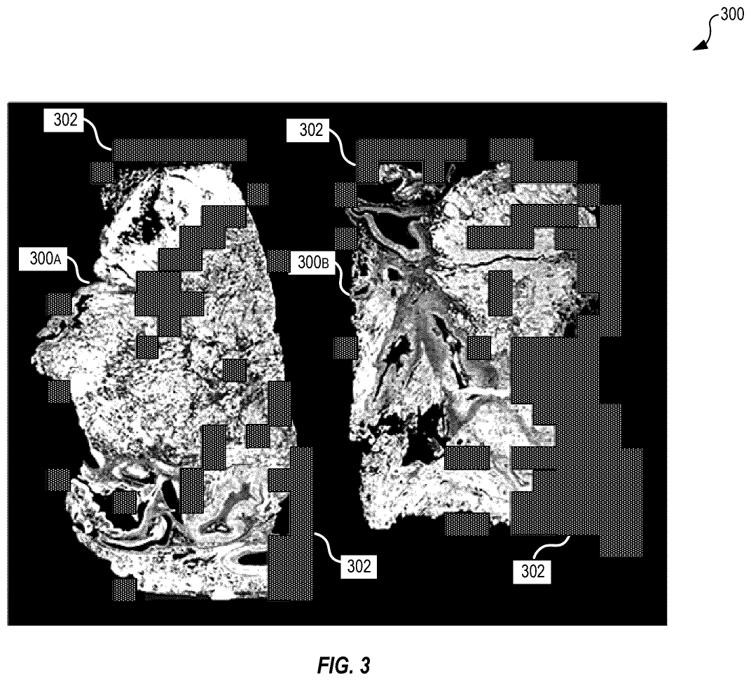

FIG. 3 illustrates an example pathology image 300 applied with a post-alignment assessment mask, according to at least one example. The pathology image 300 includes two portions 300A and 300B, which correspond to two tissue samples on one slide. A post-alignment assessment mask 302 is generated for a pair of images including the pathology image 300. The post-alignment assessment mask 302 includes multiple square masks, which can cover certain square patches in an image. The post-alignment assessment mask 302 is applied to the pathology image 300. Some of the patches in pathology image 300 are masked or filtered out.

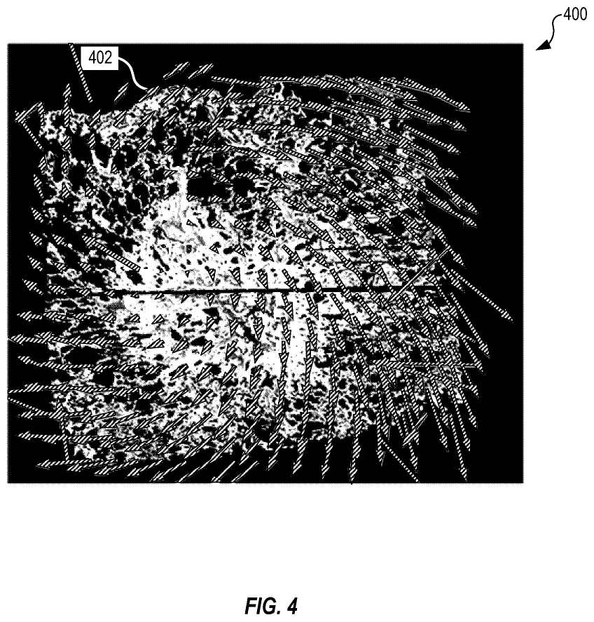

FIG. 4 illustrates an example pathology image 400 with translational vectors, according to at least one example. The pathology image 400 is for a tissue sample on a slide. Multiple arrows overlaid on the pathology image 400, for example arrow 402. An arrow represents a translational alignment vector for an image patch of the pathology image 400, indicating a direction and distance to move the image patch of the pathology image 400 so that the image patch can be aligned with a corresponding image patch in another pathology image that the pathology image 400 is supposed to be aligned with. The patterns of the translational alignment vectors may indicate an issue about the pathology image or the corresponding sample slide. In FIG. 4, the arrows are in a rotational pattern. It indicates that a portion of the tissue may be strongly adhered to the slide and a washing procedure may have caused the remaining portions of the tissue to be rotated.

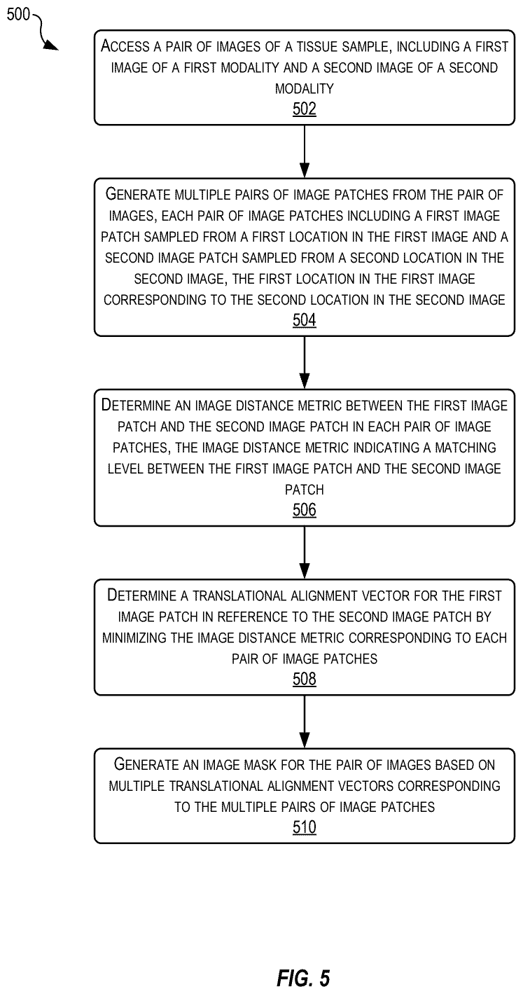

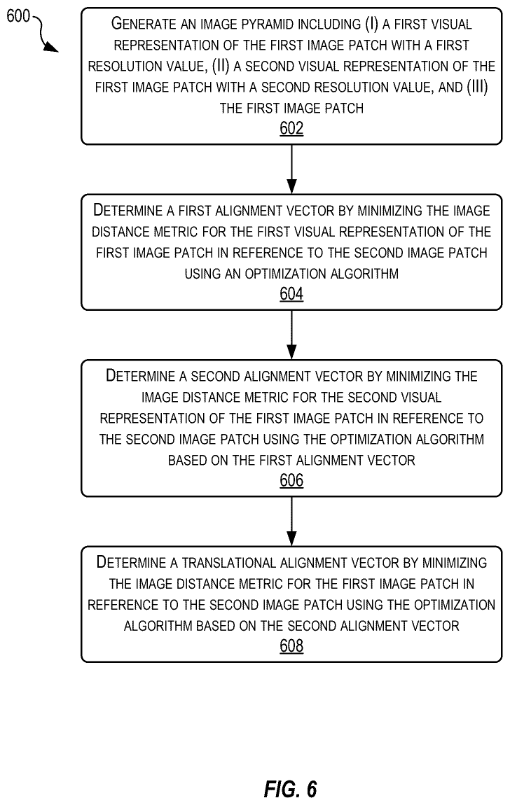

FIGS. 5 and 6 illustrate example flow diagrams showing processes 500 and 600, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

FIG. 5 illustrates an example flowchart illustrating a process 500 for generating an image mask based on alignment quality assessment, according to at least one example. The process 500 may be performed by the computing device 110 or the remote server 140.

The process 500 begins at block 502 by the computing device 110 accesses a pair of images of a tissue sample, including a first image of a first modality and a second image of a second modality. The first modality and the second modality can be different, for example one is a bright-field imaging and the other is fluorescence imaging. In some examples, the first modality and the second modality are the same, but the two images are for serial cross sections of a tissue, which can be deemed as for the same tissue sample. The pair of images can be pre-aligned by the image alignment application 116 or another alignment application.

At block 504, the process 500 includes the computing device 110 generates multiple pairs of image patches from the pair of images. Each pair of image patches includes a first image patch sampled from a first location in the first image and a second image patch sampled from a second location in the second image. The first location in the first image corresponds to the second location in the second image. The post-alignment assessment application 118 on the computing device 110 can generate multiple pairs of image patches from a pair of images at a magnification level. The image patches can be square shaped or of other shapes. In some examples, the post-alignment assessment application 118 determines a pixel intensity level at a predetermined percentile for each image patch in each pair of image patches. If one image patch has a pixel intensity level at a predetermined percentile (e.g., 95th percentile) is below a threshold level, it may indicate the corresponding image patch does not have tissue present and the corresponding pair of image patches can be discarded. In some examples, the pairs of image patches can be converted to grayscale with pixel intensity value between 0.0 and 1.0, by a normalization operation. This operation can ensure both image patches are on the same scale.

At block 506, the process 500 includes the computing device 110 determines an image distance metric between the first image patch and the second image patch in each pair of image patches. The image distance metric indicates a matching level between the first image patch and the second image patch. The lower the image distance metric number is, the better the pair of image patches matches. The image distance metric can be determined using Normalized Gradient Field technique, a Normalized Total Gradient technique, or any other suitable similarity measurements for image alignment or registration.

At block 508, the process 500 includes the computing device 110 determines a translational alignment vector for the first image patch in reference to the second image patch by minimizing the image distance metric corresponding to each pair of image patches. FIG. 6 illustrates an example flowchart illustrating a process for determining a translational alignment vector for a pair of image patches from a pair of images, according to at least one example. The process 600 may be performed by the computing device 110 or the remote server 140.

The process 600 begins at block 602 by the computing device 110 generates an image pyramid including (i) a first visual representation of the first image patch with a first resolution value, (ii) a second visual representation of the first image patch with a second resolution value, and (iii) the first image patch. The image pyramid is a 3-level pyramid. An image pyramid of different levels other than 3 can be generated using more or less visual representations of the first image patch. The image pyramid can be a Gaussian pyramid or a Laplacian pyramid, or a set of image representations generated by any other suitable image averaging techniques. The first image patch is at the bottom level of the pyramid and visual representations of the first image patches are at higher levels with reduced resolution values. In this example, the second visual representation of the first image patch is at the level above the bottom level with a resolution level less than the resolution level of the first image patch. The first visual representation of the first image patch is at the top level of the pyramid with a resolution level less than the resolution level of the second visual representation of the first image patch.

At block 604, the process 600 includes the computing device 110 determines a first alignment vector by minimizing a first image distance metric between the first visual representation of the first image patch and the second image patch using an optimization algorithm. This is the initial step for searching a location for the first image patch to minimize the image distance metric between the first image patch and the second image patch. Since the first visual representation of the first image patch has the lowest resolution level, it uses less computing resources and improves the processing speed, compared to processing the original image patch with the original resolution. Powell's conjugate direction method can be used for minimizing the image distance metric. Alternatively, other optimization methods can be used. The output of the optimization or minimization process can be a first (x,y) location for the first visual representation of the first image patch in order to minimize the image distance metric. A first translational alignment vector can be derived from the (x,y) location to represent the direction and distance to move the first visual representation of the first image patch to minimize the image distance metric.

At block 606, the process 600 includes the computing device 110 determining a second alignment vector by minimizing the image distance metric between the second visual representation of the first image patch and the second image patch using the optimization algorithm based on the first alignment vector. This is the second step for searching a location for the first image patch to minimize the image distance metric between the first image patch and the second image patch. The first (x,y) location or the first translational alignment vector obtained at block 604 (which is the initial step) can be the starting point to this second step, to minimize the image distance metric between the second visual representation of the first image patch and the second image patch. This way, it reduces time or computing consumption to minimize the image distance metric. Similar to the minimization or optimization process at block 604, a second (x,y) location or a second translational alignment vector can be obtained.

At block 608, the process 600 includes the computing device 110 determining a translational alignment vector by minimizing the image distance metric for the first image patch in reference to the second image patch using the optimization algorithm based on the second alignment vector. If there are more levels in the image pyramid between the second visual representation and the bottom level where the first image patch is, the second (x,y) location or the second translational alignment vector can serve as starting point for the next step of searching. In this example, below the second visual representation is the original first image patch in the image pyramid created at block 602. Then the second (x,y) location or the second translational alignment vector can be the starting point for searching a location for the first image patch to minimize the image distance metric between the first image patch and the second image patch. Similar to the optimization or minimization at block 604 or 606, an (x,y) location or a translational alignment vector can be obtained for minimizing the image distance metric between the first image patch and the second image patch.

With the process 600 illustrated in FIG. 6, multiple (x,y) locations or translational alignment vectors can be obtained at block 508 for the multiple pairs of image patches from the pair of images in the process 500 illustrated in FIG. 5.

Returning to FIG. 5 and the process 500, after performing the translational alignment vector determination at block 508, the process 500 includes the computing device 110 generates an image mask for the pair of images based on multiple translational alignment vectors corresponding to the multiple pairs of image patches. For example, the post-alignment assessment application 118 can determine a magnitude of each translational alignment vector corresponding to each pair of image patches, compare the magnitude with a predetermined threshold value. If the magnitude of a translational alignment vector is less than the predetermined threshold value, it indicates the alignment between the corresponding pair of image patches is at an acceptable level. If the magnitude of a translational alignment vector is equal to or greater than the predetermined threshold value, a mask patch is generated, and the corresponding pair of image patches can be masked (or filtered out). Thus, an image mask can be generated by aggregating mask patches at corresponding locations of the pair of images. The image mask can be a binary or grayscale image which can be overlaid on an image to mask certain portions of the image. For example, the image mask can be used to mask (or filter out) certain image patches with poor alignment quality from the pair of images. The update pair of images can be provided as training data to train a machine learning model. Since the training data is improved, the machine learning model can be bettered trained with the improved training data. In some examples, the (x,y) locations or the translational alignment vectors corresponding to the multiple pairs of image patches in a pair of images can be used to realign the pair of images.

FIG. 7 illustrates an example system 700 for implementing techniques relating to post-alignment assessment and processing of pathology images, according to at least one example. FIG. 7 in particular illustrates examples of components of the computer system 700, according to at least one example. The computer system 700 may be a single computer, such as a user computing device and/or can represent a distributed computing system, such as one or more server computing devices. The computer system 700 is an example of the computer device 110.

The computer system 700 may include at least a processor 702, a memory 704, a storage device 706, input/output peripherals (I/O) 708, communication peripherals 710, and an interface bus 712. The interface bus 712 is configured to communicate, transmit, and transfer data, controls, and commands among the various components of the computer system 700. The memory 704 and the storage device 706 include computer-readable storage media, such as random-access memory (RAM), read-only memory (ROM), electrically erasable programmable read-only memory (EEPROM), hard drives, CD-ROMs, optical storage devices, magnetic storage devices, electronic non-volatile computer storage, for example, Flash® memory, and other tangible storage media. Any of such computer-readable storage media can be configured to store instructions or program codes embodying aspects of the disclosure. The memory 704 and the storage device 706 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 700.

Further, the memory 704 includes an operating system, programs, and applications. The processor 702 is configured to execute the stored instructions and includes, for example, a logical processing unit, a microprocessor, a digital signal processor, and other processors. The memory 704 and/or the processor 702 can be virtualized and can be hosted within another computing system of, for example, a cloud network or a data center. The I/O peripherals 708 include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 708 are connected to the processor 702 through any of the ports coupled to the interface bus 712. The communication peripherals 710 are configured to facilitate communication between the computer system 700 and other computing devices over a communications network and include, for example, a network interface controller, modem, wireless and wired interface cards, antenna, and other communication peripherals.

In the following, further examples are described to facilitate the understanding of the present disclosure.

Clause 1. In this clause, there is provided a computer-implemented method, comprising:
accessing a pair of images of a tissue sample, comprising a first image of a first modality and a second image of a second modality;
generating a plurality of image patch pairs from the pair of images, wherein each image patch pair comprises a first image patch sampled from a first location in the first image and a second image patch sampled from a second location in the second image, wherein the first location in the first image corresponds to the second location in the second image;
determining a plurality of translational alignment vectors corresponding to the plurality of image patch pairs by:
   determining an image distance metric between the first image patch and the second image patch of each image patch pair, the image distance metric indicating a matching level between the first image patch and the second image patch of each image patch pair; and
   determining a translational alignment vector for the first image patch in reference to the second image patch by minimizing the image distance metric; and
generating an image mask for the pair of images based on the plurality of translational alignment vectors corresponding to the plurality of image patch pairs.

Clause 2. The computer-implemented method of clause 1, further comprising:
converting the plurality of image patch pairs to a plurality of grayscale patch pairs, wherein a pixel intensity in each grayscale patch pair is between 0.0 and 1.0.

Clause 3. The computer-implemented method of clause 1, wherein the first modality is bright-field imaging.

Clause 4. The computer-implemented method of clause 1, wherein the first modality is fluorescence imaging.

Clause 5. The computer-implemented method of clause 1, further comprising:
determining a first pixel intensity value at a predetermined percentile of the first image patch and a second pixel intensity value at the predetermined percentile of the second image patch;
comparing the first pixel intensity value and the second pixel intensity value to an intensity threshold value; and
discarding a corresponding image patch pair in response to determining that the first pixel intensity value or the second pixel intensity value is below less than the intensity threshold value.

Clause 6. The computer-implemented method of clause 1, further comprising:
converting the plurality of image patch pairs to a plurality of grayscale patch pairs, wherein a pixel intensity in each grayscale patch pair is between 0.0 and 1.0.

Clause 7. The computer-implemented method of clause 1, wherein the image distance metric is determined using a normalized gradient field technique.

Clause 8. The computer-implemented method of clause 1, wherein the image distance metric is determined using a normalized gradient field technique.

Clause 9. The computer-implemented method of clause 1, further comprising:
wherein obtaining a translational alignment vector for the first image patch in reference to the second image patch by minimizing the image distance metric comprises:
generating an image pyramid comprising (i) a first visual representation of the first image patch with a first resolution value, (ii) a second visual representation of the first image patch with a second resolution value, and (iii) the first image patch, wherein the second resolution value is greater than the first resolution value and less than an original resolution value of the first image patch;
determining a first alignment vector by minimizing the image distance metric for the first visual representation of the first image patch in reference to the second image patch using an optimization algorithm;
determining a second alignment vector by minimizing the image distance metric for the second visual representation of the first image patch in reference to the second image patch using the optimization algorithm based on the first alignment vector; and
determining the translational alignment vector by minimizing the image distance metric for the first image patch in reference to the second image patch using the optimization algorithm based on the second alignment vector.

Clause 10. The computer-implemented method of clause 9, further comprising:
generating the image pyramid using a Gaussian pyramid technique.

Clause 11. The computer-implemented method of clause 9, further comprising:
generating the image pyramid using a Laplacian pyramid technique.

Clause 12. The computer-implemented method of clause 1, wherein the optimization algorithm comprises Powell's conjugate direction method.

Clause 13. The computer-implemented method of clause 1, wherein the image mask is a binary mask comprising a plurality of binary values corresponding to a plurality of locations of the plurality of image patch pairs.

Clause 14. The computer-implemented method of clause 1, further comprising:
applying the image mask of the pair of images to obtain a pair of updated images; and
providing the pair of updated images as a training dataset to train a machine learning model.

Clause 15. The computer-implemented method of clause 14, further comprising:
determining a magnitude of the translational alignment vector corresponding to an image patch pair;
comparing the magnitude of the translational alignment vector with a predetermined threshold value; and
masking the image patch pair in the pair of updated images in response to determining that the magnitude of the translational alignment vector corresponding to the image patch pair is below equal to or greater than the predetermined threshold value.

Clause 16. The computer-implemented method of clause 15, further comprising:
keeping the image patch pair in the pair of updated images in response to determining that the magnitude of the translational alignment vector is less than the predetermined threshold value.

Clause 17. In this clause, there is provided a non-transitory computer-readable storage device comprising computer-executable instructions that, when executed by a computer system, cause the computer system to perform the method of any of clauses 1-16.

Clause 18. In this clause, there is provided a computer system, including:
a memory configured to store computer-executable instructions; and
a processor configured to access the memory and execute the computer-executable instructions to perform the method of clauses 1-16.

Clause 19. In this clause, there is provided a computer-implemented method, comprising:
accessing a pair of images of a tissue sample, comprising a first image of a first modality and a second image of a second modality;
generating a plurality of image patch pairs from the pair of images, wherein each image patch pair comprises a first image patch sampled from a first location in the first image and a second image patch sampled from a second location in the second image, wherein the first location in the first image corresponds to the second location of the second image;
determining a plurality of translational alignment vectors corresponding to the plurality of image patch pairs by:
   determining an image distance metric between the first image patch and the second image patch of each image patch pair, indicating a matching level between the first image patch and the second image patch of each image patch pair; and
   determining a translational alignment vector of the first image patch in reference to the second image patch by minimizing the image distance metric; and
further aligning the pair of images based on the plurality of translational alignment vectors corresponding to the plurality of image patch pairs.

Clause 20. In this clause, there is provided a non-transitory computer-readable storage device comprising computer-executable instructions that, when executed by a computer system, cause the computer system to perform the method of clause 19.

Clause 21. In this clause, there is provided a computer system, comprising:
a memory configured to store computer-executable instructions; and
a processor configured to access the memory and execute the computer-executable instructions to perform the method of clause 19.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms, such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language, such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
accessing a pair of images of a tissue sample, comprising a first image of a first modality and a second image of a second modality;
generating a plurality of image patch pairs from the pair of images, wherein each image patch pair comprises a first image patch sampled from a first location in the first image and a second image patch sampled from a second location in the second image, wherein the first location in the first image corresponds to the second location in the second image;
determining a plurality of translational alignment vectors corresponding to the plurality of image patch pairs by:
determining an image distance metric between the first image patch and the second image patch of each image patch pair, the image distance metric indicating a matching level between the first image patch and the second image patch of each image patch pair; and
determining a translational alignment vector for the first image patch in reference to the second image patch by minimizing the image distance metric; and
generating an image mask for the pair of images based on the plurality of translational alignment vectors corresponding to the plurality of image patch pairs.

2. The computer-implemented method of claim 1, further comprising:
prior to accessing a pair of images corresponding to a tissue sample, comprising a first image of a first modality and a second image of a second modality,
obtaining the first image of the first modality and the second image of the second modality; and
aligning the first image of the first modality and the second image of the second modality.

3. The computer-implemented method of claim 1, wherein the first modality is bright-field imaging.

4. The computer-implemented method of claim 1, wherein the first modality is fluorescence imaging.

5. The computer-implemented method of claim 1, further comprising:
determining a first pixel intensity value at a predetermined percentile of the first image patch and a second pixel intensity value at the predetermined percentile of the second image patch;
comparing the first pixel intensity value and the second pixel intensity value to an intensity threshold value; and
discarding a corresponding image patch pair in response to determining that the first pixel intensity value or the second pixel intensity value is less than the intensity threshold value.

6. The computer-implemented method of claim 1, further comprising:
converting the plurality of image patch pairs to a plurality of grayscale patch pairs, wherein a pixel intensity in each grayscale patch pair is between 0.0 and 1.0.

7. The computer-implemented method of claim 1, wherein the image distance metric is determined using a normalized gradient field technique.

8. The computer-implemented method of claim 1, wherein the image distance metric is determined using a normalized total gradient technique.

9. The computer-implemented method of claim 1, wherein obtaining a translational alignment vector for the first image patch in reference to the second image patch by minimizing the image distance metric comprises:
generating an image pyramid comprising (i) a first visual representation of the first image patch with a first resolution value, (ii) a second visual representation of the first image patch with a second resolution value, and (iii) the first image patch, wherein the second resolution value is greater than the first resolution value and less than an original resolution value of the first image patch;
determining a first alignment vector by minimizing the image distance metric for the first visual representation of the first image patch in reference to the second image patch using an optimization algorithm;
determining a second alignment vector by minimizing the image distance metric for the second visual representation of the first image patch in reference to the second image patch using the optimization algorithm based on the first alignment vector; and
determining the translational alignment vector by minimizing the image distance metric for the first image patch in reference to the second image patch using the optimization algorithm based on the second alignment vector.

10. The computer-implemented method of claim 9, further comprising generating the image pyramid using a Gaussian pyramid technique.

11. The computer-implemented method of claim 9, further comprising generating the image pyramid using a Laplacian pyramid technique.

12. The computer-implemented method of claim 9, wherein the optimization algorithm comprises Powell's conjugate direction method.

13. The computer-implemented method of claim 1, wherein the image mask is a binary mask comprising a plurality of binary values corresponding to a plurality of locations of the plurality of image patch pairs.

14. The computer-implemented method of claim 1, further comprising:
applying the image mask of the pair of images to obtain a pair of updated images; and
providing the pair of updated images as a training dataset to train a machine learning model.

15. The computer-implemented method of claim 14, further comprising:
determining a magnitude of the translational alignment vector corresponding to an image patch pair;
comparing the magnitude of the translational alignment vector with a predetermined threshold value; and
masking the image patch pair in the pair of updated images in response to determining that the magnitude of the translational alignment vector corresponding to the image patch pair is equal to or greater than the predetermined threshold value.

16. The computer-implemented method of claim 15, further comprising:
keeping the image patch pair in the pair of updated images in response to determining that the magnitude of the translational alignment vector is less than the predetermined threshold value.

17. A non-transitory computer-readable storage device comprising computer-executable instructions that, when executed by a computer system, cause the computer system to perform operations comprising:
accessing a pair of images of a tissue sample, comprising a first image of a first modality and a second image of a second modality;
generating a plurality of image patch pairs from the pair of images, wherein each image patch pair comprises a first image patch sampled from a first location in the first image and a second image patch sampled from a second location in the second image, wherein the first location in the first image corresponds to the second location in the second image;
determining a plurality of translational alignment vectors corresponding to the plurality of image patch pairs by:
determining an image distance metric between the first image patch and the second image patch of each image patch pair, the image distance metric indicating a matching level between the first image patch and the second image patch of each image patch pair; and
determining a translational alignment vector for the first image patch in reference to the second image patch by minimizing the image distance metric; and
generating an image mask for the pair of images based on the plurality of translational alignment vectors corresponding to the plurality of image patch pairs.

18. The non-transitory computer-readable storage device of claim 17, wherein the image mask is a binary mask comprising a plurality of binary values corresponding to a plurality of locations of the plurality of image patch pairs.

19. A computer system, comprising:
a memory configured to store computer-executable instructions; and
a processor configured to access the memory and execute the computer-executable instructions to perform operations comprising:
accessing a pair of images of a tissue sample, comprising a first image of a first modality and a second image of a second modality;
generating a plurality of image patch pairs from the pair of images, wherein each image patch pair comprises a first image patch sampled from a first location in the first image and a second image patch sampled from a second location in the second image, wherein the first location in the first image corresponds to the second location in the second image;
determining a plurality of translational alignment vectors corresponding to the plurality of image patch pairs by:
determining an image distance metric between the first image patch and the second image patch of each image patch pair, the image distance metric indicating a matching level between the first image patch and the second image patch of each image patch pair; and
determining a translational alignment vector for the first image patch in reference to the second image patch by minimizing the image distance metric; and
generating an image mask for the pair of images based on the plurality of translational alignment vectors corresponding to the plurality of image patch pairs.

20. The computer system of claim 19, wherein the operations further comprise:
applying the image mask of the pair of images to obtain a pair of updated images; and
providing the pair of updated images as a training dataset to train a machine learning model.
